(19) United States
(12) Patent Application Publication
(10) Pub. No.: US 2019/0141022 A1
(43) Pub. Date: May 9, 2019

(54) ON-PREMISE AND OFF-PREMISE COMMUNICATION

(71) Applicant: International Business Machines Corporation, Armonk, NY (US)

(72) Inventors: John A. Reeve, Winchester (GB); Matthew E. Golby-Kirk, Eastleigh (GB)

(21) Appl. No.: 15/805,274

(22) Filed: Nov. 7, 2017

(51) Int. Cl. H04L 29/06

(52) U.S. Cl. CPC H04L 63/08; H04L 67/141; H04L 63/029

(57) ABSTRACT

Proposed are concepts for managing communication between off-premise and on-premise servers. Also proposed are concepts for managing authentication between off-premise and on-premise servers. A security component may identify stored authentication data associated with a requested application, and then modify an authentication placeholder of the request using the identified authentication data to generate a modified application request comprising authentication information for authorizing the application request.

### BACKGROUND

The present disclosure relates to communicating between on-premise and off-premise platforms. The present disclosure further relates to a connectivity component (such as a switch component for example) adapted to implement such a method.

The present disclosure also relates to managing authentication between on-premise and off-premise platforms. The present disclosure yet further relates to a security component (such as a switch component for example) adapted to implement such a method.

The present disclosure further relates to a computer program product comprising computer-readable program code that enables a processor of a processing system to implement such methods.

Communication between on-premise and off-premise platforms is required in a Software as a Service (SaaS) environment. SaaS is a software licensing and delivery model in which software is licensed on a subscription basis and is centrally hosted by an off-premise platform (such as a shared computing resource or a cloud computing resource accessible via the Internet for example). SaaS is typically accessed by users of an on-premise platform (for example, using a thin client via a web browser).

On-premise platforms are well-established and considered to provide a good level of security because data is stored and handled internally, e.g., within an internal private network. Off-premise platforms (such as cloud computing resources) are a relatively recent and evolving concept. Generally, reference to off-premise resources or platforms is taken to refer to a concept for enabling ubiquitous, convenient, and on-demand access via Internet to shared pools of configurable off-premise (e.g. remotely located) computing resources such as networks, applications, servers, storages, applications, functionalities, and the like which are accessible via the Internet. Conversely, reference to on-premise resources or platforms is taken to refer to a concept of local or private computing resources such as networks, servers, storage devices, application, etc. that are situated locally or within/behind a virtual boundary (often behind a firewall).

Applications running on an off-premise platform (e.g. in the cloud) may need to access systems or applications of an on-premise platform (such as queuing systems, databases or packaged applications). Such access may employ an authentication protocol or process which requires authentication information (such as a user name and password for example) to be provided when establishing an initial connection between then off-premise and on-premise platforms. To use such an authentication protocol in an application running on an off-premise platform will typically require the off-premise platform to have access to the authentication information (e.g. private or sensitive security credentials). The storage and management of such authentication information can cause security issues, particularly if the off-premise platform is shared. Accordingly, moving some or all of application to an off-premise platform can raise security concerns and/or risks, which may in turn reduce or limit the acceptance of employing off-premise systems.

For example, security concerns have been raised regarding the concept of having application software running in a System as a Service (SaaS) environment which has access to security credentials in order to connect to on-premise systems of record. Attempts to address such concerns have included limiting the access and not storing full security credentials off-premise and instead issuing security tokens that have limited rights and/or expire after a short length of time. However, existing or legacy computer systems do not typically support such approaches and may, for example, require conventional authentication information (such as username and password for example).

### SUMMARY

The present disclosure seeks to provide a component for managing communication between off-premise and on-premise platforms that can expose an application and enables dynamic access without the need for a VPN or mounted Network Application (NFS).

The present disclosure also seeks to provide a component for managing authentication between off-premise and on-premise platforms that support the use of conventional authentication information (such as user name and password) without requiring the storage of such authentication information at an off-premise platform (e.g. in a cloud processing environment). The present disclosure further seeks to provide a computer program product including computer program code for implementing the proposed concepts when executed on a processor. The present disclosure yet further seeks to provide a network component (such as a connectivity or a security component) adapted to execute this computer program code.

According to an embodiment of the present disclosure there is provided a connectivity component adapted to manage communication between off-premise and on-premise servers. The connectivity component comprises an application path data store adapted to store application path data associated with one or more applications. The connectivity component also comprises a first communication component adapted to receive an application request from an off-premise server or an on-premise server, the application request comprising an authentication placeholder devoid of correct authentication information for authorizing the application request. The connectivity component also comprises a routing component adapted to determine a requested application based on the received application request and to identify stored application path data associated with the requested application. The connectivity component further comprises a second communication component adapted to communicate the application event request to an on-premise server or off-premise server based on the identified application path data.

According to another embodiment of the present disclosure there is provided a security component adapted to manage authentication between off-premise and on-premise servers. The authentication component comprises an authentication data store adapted to store authentication data associated with one or more applications. The authentication component also comprises a first communication component adapted to receive an application request from an off-premise server or an on-premise server, the application request being directed to a target on-premise server or off-premise server according to application path data and comprising an authentication placeholder devoid of correct authentication information for authorizing the application request. The authentication component further comprises an authentication component adapted to determine a requested application based on the received application request, to identify stored authentication data associated with the requested application, and to modify the authentication placeholder using the identified authentication data to generate a modified application request comprising authentication information for authorizing the application request. The authentication component also comprises a second communication component adapted to communicate the modified application event request to the target on-premise server or off-premise server.

Proposed is a concept of communicating application requests between off-premise and on-premise sites/resources. This may allow an agent running in a cloud system, for example), to act like a service of an on-premise application. A cloud-based service using the application may then call or request an application like it would for any other local application.

Also, proposed concepts may enable existing authentication protocols (e.g. requiring username and password, or other legacy authentication details) to still be implemented without the authorization information/credentials being stored at the off-premise platform (e.g. in a cloud-based server). It may also require no modification to how the security/authentication protocol works, thus enabling both the client service using it and the server accepting application requests to carry on working without any modifications.

Such proposals may provide a system that allows a service or application running in the cloud to make connections to on-premise systems without providing the password or security credential(s) in the connection request. The service/application may instead use a placeholder (such as a false, dummy or empty password field) when requesting the connection. In this way, a request may comprise an authentication placeholder (e.g. a dummy password of “XXXXXXXXXX”) that is devoid of correct authentication information or security credentials. The service/application may then connect to a local component in the cloud instead of directly to the end system at the on-premise platform. The local (e.g. cloud) component agent may then connect to a server component (e.g. a connectivity component or communication management agent) running in the cloud using TCPIP which then forwards the TCPIP traffic to the on-premise server (e.g. a security component or authentication agent). The on-premise server component may allow on-premise components or agents to receive the TCPIP traffic. The security/authentication component/agent may then examine the TCPIP data and extract the username being used based on the type of connection protocol being used. The component/agent may then retrieve authentication information or security credentials (e.g. password or pin-code) from an authentication data store that has the required authentication information or security credentials for each user name (and for each application/system it may connect to). The component/agent may then take the retrieved authentication information or security credentials and replace the authentication placeholder with the real, retrieved authentication information/security credentials. The component/agent may then establish connection to the on-premise system/application using the retrieved (i.e. correct) authentication information or security credentials.

There may be provided a system that allows an application running in the cloud to make connections to on-premises systems via a password replacing component. Sensitive information (such as a password) may therefore be prevented from being provided to a cloud platform. Instead, an agent or security component running on-premise may store the real authentication information (e.g. passwords, pin-codes, etc.) securely, then parse and analyze a request to replace a place-holder with the real authentication information. In this way, embodiments may be thought of as injecting correct/real authentication information into a request when passing from an off-premise platform to an on-premise platform.

Proposed embodiments may therefore avoid exposure of authentication information or security credentials to the off-premise system(s) and may thus prevent or hinder the authentication information or security credentials from being compromised in the off-premise systems. Also, the connection from the off-premise agent to the off-premise connectivity component and to the on-premise system may be secured using HTTPS to stop any other application being able to access the end systems.

Proposed concepts may allow applications to be split into a set of applications which can be configured to run either in the off-premise (e.g. cloud) environment, or on-premise environment. Applications may then be able to invoke each other and exchange data in an optimal manner without exposing authentication information or security credentials in the off-premise environment. For example, the applications may be separated such that the ones which require access to on-premise systems of record run in the on-premise servers, and ones that would benefit from off-loading their computational intensive processing run in the off-premise infrastructure. A connectivity component, such as a switch component, is thus proposed which may manage communication between the off-premise and on-premise systems by receiving an application request from an off-premise server and then communicating the request to an on-premise server based on identified application path data. Such application path data may be identified by the connectivity component using a data store which is adapted to store application path data associated with on-premise applications.

The request may comprise an authentication placeholder, such as dummy or false authentication information, thus avoiding correct authentication information being required and/or exposed by the off-premise server. A security component may thus also be proposed which may receive the request at on-premise server and then process the request to replace the modify or replace the authentication placeholder with correct authentication information (stored at the on-premise platform), thereby generating a modified request comprising correct authentication information.

Proposed concepts may avoid mapping of application paths between the off-premise system (e.g. SaaS environment) and the on-premise system. Also, proposed embodiments may avoid the use of private or sensitive authentication information or security credentials at the off-premise platform. Instead, embodiments may be configured to only exchange data between the application data paths available in each environment, and to also avoid the exchange of authentication information between off-premise and on-premise platforms. This may provide the performance benefit of reducing an amount of network traffic over the internet. It may also avoid having to expose security credentials to off-premise parts.

In some environments, the first communication component of the connectivity component may be adapted to establish a secure tunnel for receiving the application request. Similarly, the second communication component may be adapted to establish a secure tunnel for communicating the application request. For example, a mutually authenticated TLS tunnel connection may be to transfer data between the two environments. Secure communications between off-premise and on-premise platforms may therefore be provided.

In an embodiment, the connectivity component may further comprise a registration module adapted to receive application path data from at least one of: an application of an off-premise server; an application of an on-premise server; an off-premise server module; and an on-premise server module. The registration module may then be adapted to store received application path data in the application path data store. Embodiments may therefore employ the concept of registering information about accessing or making use of an application with the connectivity component so that the connectivity component can identify how to handle (e.g. where to communicate) a request for said application. By using such a registration concept, a data store of application path data may be dynamically updated or maintained to reflect changes in available applications or severs.

For example, the registration module may be adapted to remove application path data from the data store in response to at least one of: an application; a server; and a file system becoming inaccessible (e.g. being disconnected, terminated, or powered-down). Proposed concepts may therefore be thought of as providing a dynamically updated store of application path information representing applications that may be accessible and how (e.g. application name, server location/address, supported applications, etc.). Embodiments may therefore provide a connectivity component which can adapt to implementation specifics and cater for changes in available resources (e.g. applications, services and/or file systems), thereby providing a high degree of flexibility and adaptability.

By way of example, the application path data may comprise at least one of: an application name; a server identification; a server address; an application version identifier; supported applications; permitted applications; permission information; and checksum information. Application path data may, for instance, comprise information relating to the identity of an application. Such identification information may then be used to match an application request to a system running the required application. Alternatively, or additionally, application path data may include information relating to a version or checksum in order to enable more complex matching. For example, the requester could provide a conditional call/request that calls/requests an application named “application1” which is at least at level 3 or higher. Similarly, the requester could ask to run an application named “application2” that has a check sum of 22983098923 so that it could ensure it was calling a application that had the correct code associated with it.

Alternatively, or additionally, application path data may include information relating to the relative location of an application path.

Application path data may comprise information to identify a system that an application is running or available on. This may be purely used as operational information so an administrator can see what systems are offering particular applications. However, it may also be used for additional levels of security where only certain systems are allowed to register. Thus, application path data may be thought of as comprising information relating to the location of (i) an application or (ii) a data path of the application.

In an embodiment, the off-premise server may comprise a cloud sever, and the application request may be provided by a service of the cloud server. Embodiments may therefore be employed in a SaaS environment for the provision of cloud-based services over the internet for example. By way of example, the application request may further comprise at least one of: an application name; an event; a data payload; and entry point data. The application request may therefore comprise information relating to the application, an event (e.g. read, write, delete, append, purge, edit, etc.) to be completed by the application, data to be processed by the application, and/or and entry point in the application that the request would be made to. An application request may thus comprise an authentication portion, an identification portion and a payload portion. Inclusion of entry point data (such as path identification information, for example) in an application request may enable specification of an entry point in application that the request is made to. For example, an application called “applicationl” could have two entry points called “entryl” and “entry2”. The application request may then include the application name and the entry point within the application, such as “application1/entry1” for example. If no entry point information is employed, a default entry point (e.g. start or code beginning) may be used.

In embodiments, the first communication component may be adapted to receive an application request from an off-premise server, and the second communication component may be adapted to communicate the application request to an on-premise server based on the identified application path data. In this way, requests may be received from off-premise resources and routed by the connectivity component to the appropriate on-premise resource(s).

Alternatively, or additionally, the first communication component may be adapted to receive an application request from an on-premise server, and the second communication component may be adapted to communicate the application request to an off-premise server based on the identified application path data. This arrangement may enable an on-premise resource to transmit a request for an off-premise resource via the connectivity component so that the request is routed to the appropriate off-premise resource.

Also, in some embodiments, the second communication component may be adapted to receive a response to the communicated application request, and the first communication component may be adapted to communicate the received response to the application. In this way, a response to an application request may be communicated back to the originator of the application request. Proposed connectivity components may therefore provide for the management of communication between off-premise and on-premise platforms so that requests and responses are appropriately delivered whilst avoiding excessive communication traffic.

Embodiments may be employed in a switch module. For example, there may be provided a switch module comprising a connectivity component according to a proposed embodiment. Also, embodiments may be implemented in a server device. Such a server device may be a cloud-based server resource accessible via the Internet.

In some environments, the first communication component of the security component may be adapted to establish a secure tunnel for receiving the application request. Similarly, the second communication component may be adapted to establish a secure tunnel for communicating the modified application request. For example, a mutually authenticated TLS tunnel connection may be to transfer data between the two environments. Secure communications between off-premise and on-premise platforms may therefore be provided.

In an embodiment, the security component may further comprise a registration module adapted to receive authentication data from at least one of: an application of an off-premise server; an application of an on-premise server; an off-premise server module; and an on-premise server module. The registration module may then be adapted to store received authentication data in the authentication data store. Embodiments may therefore employ the concept of registering information about authenticating or authorizing an application with the security component so that the security component can identify how to handle (e.g. how to modify the authentication placeholder) a request for said application. By using such a registration concept, a data store of authentication data may be dynamically updated or maintained to reflect changes in authentication/authorization.

For example, the registration module may be adapted to remove authentication data from the authentication data store in response to at least one of: an application; a server; and a file system becoming inaccessible (e.g. being disconnected, terminated, or powered-down). Proposed concepts may therefore be thought of as providing a dynamically updated store of authentication information representing security credentials (e.g. user names, password, pin codes, permissions, etc.) that may be used to authorize use of an application). Embodiments may therefore provide a security component which can adapt to implementation specifics and cater for changes in authentication details, thereby providing a high degree of flexibility and adaptability.

By way of example, the authentication data may comprise at least one of: a password; a pin-code; permission information; and checksum information. Authentication data may, for instance, comprise information relating to the security credentials required for use of an application. Such identification information may then be used to populate or modify the authentication placeholder of an application request.

Authentication data may comprise information to identify a user (e.g. originator of an application request) to an application. This may be purely used as security information so an application can authorize execution.

In an embodiment, the off-premise server may comprise a cloud sever, and the application request may be provided by a service of the cloud server. Embodiments may therefore be employed in a SaaS environment for the provision of cloud-based services over the internet for example.

In embodiments, the first communication component may be adapted to receive an application request from an off-premise server, and the second communication component may be adapted to communicate the modified application request to a target on-premise server according to application path data associated with the application request. In this way, requests may be received from off-premise resources, modified to include authentication information from an on-premise data store, and then routed by the security component to the appropriate on-premise resource(s).

Alternatively, or additionally, the first communication component may be adapted to receive an application request from an on-premise server, and the second communication component may be adapted to communicate the modified application request to an off-premise server. This arrangement may enable an on-premise resource to transmit a request for an off-premise resource via the security component so that the request is routed to the appropriate off-premise resource and contains security credentials (i.e. authentication information) from an on-premise data store.

Also, in some embodiments, the second communication component may be adapted to receive a response to the communicated modified application request, and the first communication component may be adapted to communicate the received response to the application. In this way, a response to an application request may be communicated back to the originator of the application request via the security component. Proposed security components may therefore provide for the management of communication and authentication between off-premise and on-premise platforms so that requests and responses are appropriately delivered whilst avoiding the exposure of private or sensitive authentication information at an off-premise server.

Embodiments may be employed in a switch module. For example, there may be provided a switch module comprising a security component according to a proposed embodiment. Also, embodiments may be implemented in a server device. Such a server device may be a cloud-based server resource accessible via the Internet.

According to another aspect, there is provided a computer-implemented method of managing communication between off-premise and on-premise servers. The method comprises storing, in an application path data store, application path data associated with one or more applications. The method also comprises receiving an application request from an off-premise server or an on-premise server, the application request comprising an authentication placeholder devoid of correct authentication information for authorizing the application request. The method further comprises determining a requested application based on the received application request. The method yet further comprises identifying stored application path data associated with the requested application, and communicating the application request to an on-premise server or off-premise server based on the identified application path data.

According to yet another aspect, there is provided a computer-implemented method of managing authentication between off-premise and on-premise servers. The method comprises storing, in an authentication data store, authentication data associated with one or more applications. The method also comprises receiving an application request from an off-premise server or an on-premise server, the application request being directed to a target on-premise server or off-premise server according to application path data and comprising an authentication placeholder devoid of correct authentication information for authorizing the application request. The method further comprises determining a requested application based on the received application request. The method yet further comprises identifying stored authentication data associated with the requested application, and modifying the authentication placeholder using the identified authentication data to generate a modified application request comprising authentication information for authorizing the application request. The method further comprises communicating the modified application request to the target on-premise server or off-premise server.

According to another embodiment of the present disclosure, there is provided a computer program product for managing communication between off-premise and on-premise servers, the computer program product comprising a computer readable storage medium having program instructions embodied therewith, the program instructions executable by a processing unit to cause the processing unit to perform a method according to one or more proposed embodiments when executed on at least one processor of a data processing system.

According to another embodiment of the present disclosure, there is provided a computer program product for managing authentication between off-premise and on-premise servers, the computer program product comprising a computer readable storage medium having program instructions embodied therewith, the program instructions executable by a processing unit to cause the processing unit to perform a method according to one or more proposed embodiments when executed on at least one processor of a data processing system.

According to yet another aspect, there is provided a processing system comprising at least one processor and the computer program product according to one or more embodiments, wherein the at least one processor is adapted to execute the computer program code of said computer program product.

The processing system may be adapted to act as a switching or authentication component between an on-premise server and an off-premise server. The processing system may be adapted to implement a part of an off-premise platform, such as a cloud-based system or server. Thus, there may be proposed a system which evaluates an application request and determines where to communicate the request based on stored data associated with applications. There may also be proposed a system which communicates a request comprises dummy or invalid authentication information, and then replaces the dummy/invalid authentication information at a secure on-premise environment. Taking such an approach may enable dynamic and secure application access between on-premise and off-premise platforms without the need for a VPN or NFS (or similar mounted application).

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A depicts a simplified block diagram of an example implementation of an embodiment.

FIG. 1B is a modified version of FIG. 1A, wherein components of the switching component and security component are illustrated.

FIG. 2 depicts an example of the embodiment of FIG. 1 wherein a cloud-based application of the first server requests a first database application.

FIG. 3 depicts a flow diagram of a method for managing communication and authentication between off-premise and on-premise resources according to an embodiment.

FIG. 4 illustrates a cloud system node according to an embodiment.

FIG. 5 illustrates a cloud computing environment according to an embodiment.

FIG. 6 illustrates cloud abstraction mode layers according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

It should be understood that the Figures are merely schematic and are not drawn to scale. It should also be understood that the same reference numerals are used throughout the Figures to indicate the same or similar parts.

An “application” may be understood as being a processing resource, routine, set of instructions, data system, or processing construct which may be provided in a structured or ordered manner. A path may therefore be used to represent a location within a data storage construct (for the purpose of accessing an application instruction at a location within the construct for example). Using such an application, actions or events may be undertaken to access, modify, change, remove, alter, etc. files or data. Such events may include reading, writing, deleting, modifying, purging, appending or the like. Thus, when employed for integration between off-premise and on-premise resources (such as may be done in cloud-based provision of software to a user of an on-premise resource, or as part of a SaaS environment), one or more of the instructions, routines or processes of an application may be accessed by an external system, thus requiring communication between the off-premise and on-premise resources.

Proposed are concepts for establishing and/or managing and authenticating communication between off-premise and on-premise platforms, wherein the data processing applications may be split or separated into applications which can be implemented in the off-premise environment or in the on-premise environment and wherein the applications may invoke each other and exchange data via a connectivity component (e.g. a switching module). A connectivity component may thus be implemented to receive application requests and forward such requests to the appropriate destination (e.g. application path), wherein the appropriate destination is determined based on a data store comprising information about the applications. Also, a security component may be implemented to receive application requests and process such requests to incorporate authentication information into the request, the authentication information being stored at a secure on-premise resource. In this way, application requests may be communicated between off-premise and on-premise platforms without containing sensitive or private authentication information, and then such authentication information may be inserted into the application requests at a secure on-premise location.

Embodiments may therefore propose a concept of injecting real/correct authorization information (e.g. password, pin-code, user ID, security token, etc.) into an application request at a secure on-premise platform. Such injection of real/correct authorization information may be undertaken based on content of an application request received from an off-premise platform.

By way of further example, proposed embodiments may replace a username used by an application in the cloud with be a different name from the real/correct username. The on-premise security component (e.g. authorization agent) may then maintain a store of authentication information that maps the false/dummy username to the real/correct username and password. This may provide the advantage of not allowing the off-premise platform (e.g. cloud system) to know any real/correct authorization information (such as real usernames, for example). Embodiments may therefore reduce network traffic and/or avoid having to expose security credentials to off-premise parts.

For instance, proposed concepts may enable an on-premise application to be invoked by an off-premise application, and/or vice versa, wherein a conventional security protocol (such as username and password) can be used without the security credential (e.g. password) being known by the off-premise application. Applications that may benefit from being implemented on the off-premise systems may therefore be run in off-premise servers, whereas applications that may benefit from being implemented on the on-premise systems (e.g. those requiring the storage capabilities or security of on-premise systems) may be run in on-premise servers.

Illustrative embodiments may therefore provide concepts for securely communicating between off-premise resources and on-premise resources. Secure and dynamic distributed processing and data storage optimization may therefore be provided by proposed embodiments. Modifications and additional steps to a traditional SaaS implementation may also be proposed which may enhance the value and utility of the proposed concepts.

Illustrative embodiments may be utilized in many different types of distributed processing environments. In order to provide a context for the description of elements and functionality of the illustrative embodiments, the figures are provided hereafter as an example environment in which aspects of the illustrative embodiments may be implemented. It should be appreciated that the figures are only exemplary and not intended to assert or imply any limitation with regard to the environments in which aspects or embodiments of the present disclosure may be implemented. Many modifications to the depicted environments may be made without departing from the spirit and scope of the present disclosure. Moreover, the system may take the form of any of a number of different processing devices including client computing devices, server computing devices, a tablet computer, laptop computer, telephone or other communication devices, personal digital assistants (PDAs), or the like. In some illustrative examples, an off-premise device and an on-premise device may comprise a portable computing device that is configured with flash memory to provide non-volatile memory for storing operating system files and/or user-generated data, for example. Thus, the system may essentially be any known or later-developed processing system without architectural limitation.

A proposed concept may enhance a cloud-based service provisioning system by reducing network traffic or by enabling conventional security protocols to be implemented between the cloud and on-premise resources without private or sensitive security credentials needing to be exposed to the cloud environment. Embodiments may enable application requests to be analyzed and forwarded to appropriate destinations off-premise or on-premise to establish connectivity between off-premise and on-premise platforms. The application requests may employ or adhere to security protocols without having to include security credentials when being communicated between off-premise and on-premise platforms. Such proposals can extend or improve the processing capabilities, security and/or efficiency of a cloud-based software delivery system.

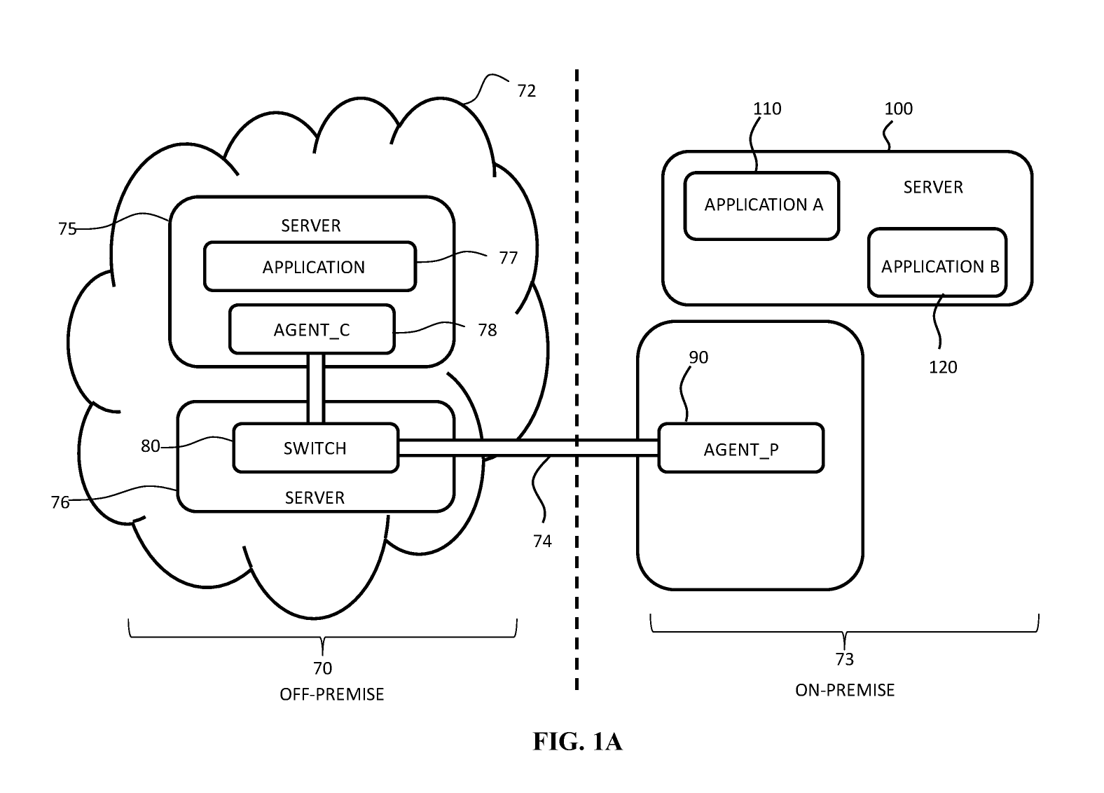

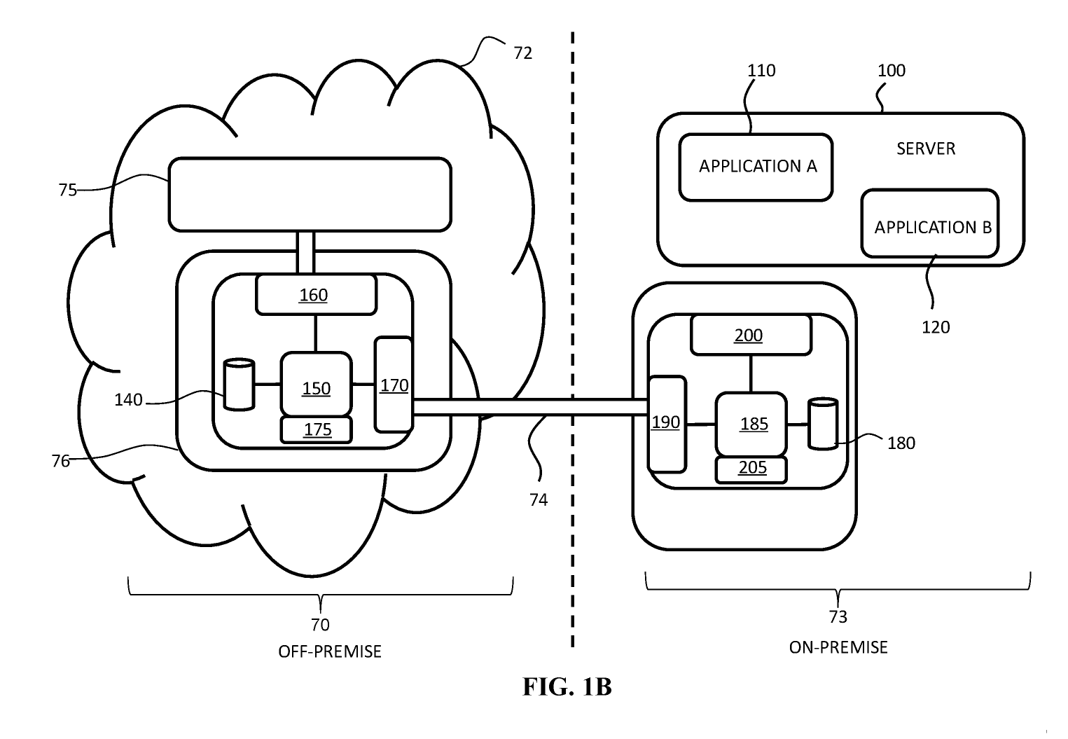

Turning now to FIGS. 1A & 1B, an example implementation of an embodiment will now be described. Here, a cloud-based software delivery service comprises off-premise resources 70 in the cloud 72 which are accessible to on-premise resources 73 via an Internet communication link 74.

The off-premise resources 70 comprise first 75 and second 76 off-premise servers. The first off-premise server 75 is a cloud-based server 75 and comprises an application 77 and a first server module/agent 78 (labeled “AGENT C”). The second off-premise server 76 is a cloud-based server 76 and comprises a switching component (i.e. connectivity component) 80 adapted to manage communication between the first off-premise server 75 and the on-premise resources 73. The on-premise resources 73 comprise an authentication component (i.e. security component 90 (labeled “AGENT P”) adapted to manage authentication between the first off-premise server 75 and the on-premise resources 73. The on-premise resource 73 also comprise first 110 (“APPLICATION A”) to third 120 (“APPLICATION B”) applications, and an application server 100 implementing the first 110 and second 120 applications.

Referring now to FIG. 1B, the switching component 80 and authentication component 90 is shown in more detail.

The switching component 80 comprises: a data store 140; a routing component 150; a first communication component 160; and a second communication component 170. The data store 140 comprises an application path data store adapted to store application path data associated with applications that are implemented by the on-premise resources 30. By way of example, the application path data may comprise information relating to application names, server identifications, server addresses, application version identifiers, supported applications, permitted applications, permission information, authentication information, and checksum information. The application path data may be provided to the data store 140 by servers or applications when they are made available by the on-premise resources 73. For this purpose, the switching component 80 comprises a registration module 175 that is adapted to receive application path data from at least one of: an application of an off-premise server; an application of an on-premise server; an off-premise server module; and an on-premise server module. The registration module 175 may be adapted to store received application path data in the application path data store 140, thus enabling the concept of registering information with the switching component 80 so that it may identify how to handle (e.g. where to communicate) an application request. Also, the registration module 175 may be adapted to remove information from the application path data store 140 in response to an application and/or server becoming inaccessible (e.g. being disconnected, terminated, or powered-down). A registering server or application may therefore register information to identify an application that it provides. This registered information can then be used to match an event call/request for an application to a system running the required application.

Put another way, the data store 140 may be adapted to be dynamically updated or maintained to reflect changes in available applications or resources.

The data store 140 may therefore be thought of as providing a dynamically updated store of application information representing applications that may be accessible. In this way, the switching component 80 may adapt to implementation specifics and cater for changes in available resources (e.g. service and/or applications), for example for the registration/deregistration of application path data to/from the data store 140.

The first communication component 160 is adapted to receive an application request from the application 77 of the first off-premise server 75 (via the first server module/agent 78). For this purpose, the first communication component 160 is adapted to establish a secure tunnel for receiving the application request.

An application request is a request to access or invoke an application provided by the on-premise resources 73. By way of example, an application request of this embodiment comprises an identification portion, an authentication placeholder and a payload portion. The identification portion includes information relating to the identification of an application (such as an application name for example). The authentication placeholder includes incorrect, symbolic, figurative, abstract or improper authentication information (such as a false, dummy or empty password field) that may be indicative of a security protocol implemented to authorize use of the requested application. For instance, where a requested application requires a username and password in order to authenticate or authorizes application usage, the authentication placeholder may comprise a dummy password of “XXXXXXXXXX” for example, thus representing a password is required but being devoid of correct authentication information or security credentials. The payload portion comprises a data payload (such as a file location information (e.g. directory or path), an operation or instruction (e.g. read, write, delete, append, purge, edit, etc.) to be completed by the application, non-sensitive authentication information (e.g. username, user ID, account number, etc.), and data for use in/by the application for example).

Upon receiving an application request, the first communication component 160 passes the received request to the routing component 150. The routing component 150 is adapted to process the received request in conjunction with data stored in the data store 140 in order to determine a requested application and stored application path data associated with the requested application. By way of example, the routing component 150 is adapted to analyze the identification portion of the received application request to identify the requested application (for example, based on an application name included in the identification portion). Further, based on the identified requested application, the routing component 150 is then adapted to query the data store 140 to identify application path data that is associated with the identified requested application.

The routing component 150 passes the received application request to the second communication component 170 along with the identified application path data associated with the identified requested application. The second communication component 170 is adapted to communicate the received application request to the on-premise resources 73 based on the identified application path data associated with the identified requested application. For this purpose, the second communication component 170 is adapted to establish a secure tunnel for communicating the application request. For example, the second communication component 170 may establish a mutually authenticated TLS tunnel connection between the switching component 80 and the on-premise security component 90.

Thus, from the description above, the switching component 80 may be thought of as having first and second secure components for establishing tunnels with off-premise and on-premise server modules, respectively. The switching component 80 may also be thought of as including a registration component that is adapted to register and store (in a data store of the switching component 80) application path data (e.g., application names, server IDs, server addresses, application version identifiers, supported applications, permitted applications, permission information, non-sensitive or public authentication information and checksum information) associated with applications. Applications or servers may therefore register information with the switching component 80 when they connect and/all when a configuration changes. Such information may also be deregistered (e.g. removed or deleted from the data store) when an application or server becomes inaccessible (e.g. is disconnected, powered down or otherwise unavailable). Received calls (e.g. requests) to execute an application may thus be analyzed by the switching component 80 and be used to query the dynamically maintained data store to identify application path data indicative of where to communicate the requested event.

The security component 90 comprises: an authentication data store 180; an authentication component 185; a first communication component 190; and a second communication component 200.

The authentication data store 180 comprises an authentication information data store adapted to store authentication data associated with applications that are implemented by the on-premise resources 30. By way of example, the application path data may comprise information relating to: passwords; pin-codes; permission information; and checksum information. The application path data may be provided to the authentication data store 180 by servers or applications when they are made available by the on-premise resources 73. For this purpose, the security component 90 comprises a registration module 205 that is adapted to receive authentication data from at least one of: an application of an off-premise server; an application of an on-premise server; an off-premise server module; and an on-premise server module. The registration module 205 may be adapted to store received authentication data in the authentication data store 180, thus enabling the concept of registering authentication information with the security component 90 so that it may identify authentication information needed for an application request. Also, the registration module 205 may be adapted to remove information from the authentication data store 180 in response to an application, a server, and/or an application becoming inaccessible (e.g. being disconnected, terminated, or powered-down) and/or a user de-activating/removing an account. A registering server or application may therefore register information to authenticate or authorize a user or account in respect of an application that it provides. This registered authentication information can then be used to replace or populate an authentication placeholder of an application call/request received by the security component 90.

Put another way, the authentication data store 180 may be adapted to be dynamically updated or maintained in order to reflect changes in users, accounts, resources and/or available applications. The authentication data store 180 may therefore be thought of as providing a dynamically updated store of authentication information for authenticating or authorizing the use of applications that may be accessible. In this way, the security component 90 may adapt to implementation specifics and cater for changes in available users, accounts, resources and/or available applications, for example for the registration/deregistration of user authentication information to/from the authentication data store 180.

The first communication component 190 is adapted to receive an application request from off-premise server 76 (via the switching component 80). For this purpose, the first communication component 190 is adapted to establish a secure tunnel for receiving the application request.

As detailed above, an application request is a request to access or invoke an application provided by the on-premise resources 73. The application request of this embodiment comprises an authentication placeholder which includes incorrect, symbolic, figurative, abstract or improper authentication information (such as a false, dummy or empty password field) that may be indicative of a security protocol implemented to authorize use of the requested application.

Upon receiving an application request, the first communication component 190 of the security component 90 passes the received request to the authentication component 185. The authentication component 185 is adapted to process the received request in conjunction with data stored in the authentication data store 180 determine a requested application and identify stored authentication data associated with the requested application. By way of example, the authentication component 185 is adapted to analyze the identification portion of the received application request to identify the requested application (for example, based on an application name included in the identification portion). Also, the authentication component 185 is adapted to analyze at least one of the authentication placeholder and the data payload portion of the received application request to identify authentication information of the authentication data store 180 (for example, based on a username included in the data payload portion). Further, based on the identified authentication information, the authentication component 185 is then adapted to modify the authentication placeholder of the application request to generate a modified (e.g. new or updated) application request comprising authentication information for authorizing the application request. For example, the authentication component 185 may replace the false, dummy or empty password field with correct, real or accurate authentication information retrieved from the authentication data store 180 to generate a revised/final application request.

The authentication component 185 passes the revised/final application request to the second communication component 200 along with the identified application path data associated with the requested application. The second communication component 200 is adapted to communicate the revised/final application request to the on-premise resources 73 based on the identified application path data associated with the requested application. For this purpose, the second communication component 200 is adapted to establish a secure tunnel for communicating the revised/final application request.

Thus, from the description above, it will be appreciated that the security component 90 may be thought of as having first and second secure components for establishing tunnels with off-premise and on-premise server modules, respectively. The security component 90 may also be thought of as including an authentication component that is adapted to register and store (in a data store of the security component 90) authentication data (e.g., passwords; pin-codes; permission information; usernames; security tokens, checksum information, etc.) associated with user and applications. Users, applications or servers may therefore register information with the security component 90. Such information may also be deregistered (e.g. removed or deleted from the authentication data store) when an application or server becomes inaccessible (e.g. is disconnected, powered down or otherwise unavailable) when a user de-registers/de-activates an account. Received calls (e.g. requests) to execute an application may thus be analyzed by the security component 90 and be used to query the dynamically maintained authentication data store 180 to identify authentication data which can then be inserted into the application request (e.g. by replacing an authentication placeholder of the request). In this way, private or sensitive authentication data may be maintained on-premise and not communicated or exposed to the off-premise platform(s).

The security component 90 may therefore enable a cloud application to call/request an application of an on-premise server, wherein the call/request does not comprise sensitive authentication information. The call/request can be processed by the security component 90 to insert or incorporate appropriate authentication information at a secure on-premise platform, thereby creating a new or modified call/request which includes correct (and potentially private/sensitive authentication information). The new or modified call/request may can then be passed to the appropriate on-premise server by the security component 90. Conversely, the security component 90 may enable an on-premise application to call an application of an off-premise server (e.g. by stripping private or sensitive authentication information out of the call prior to communicating the call to the off-premise server).

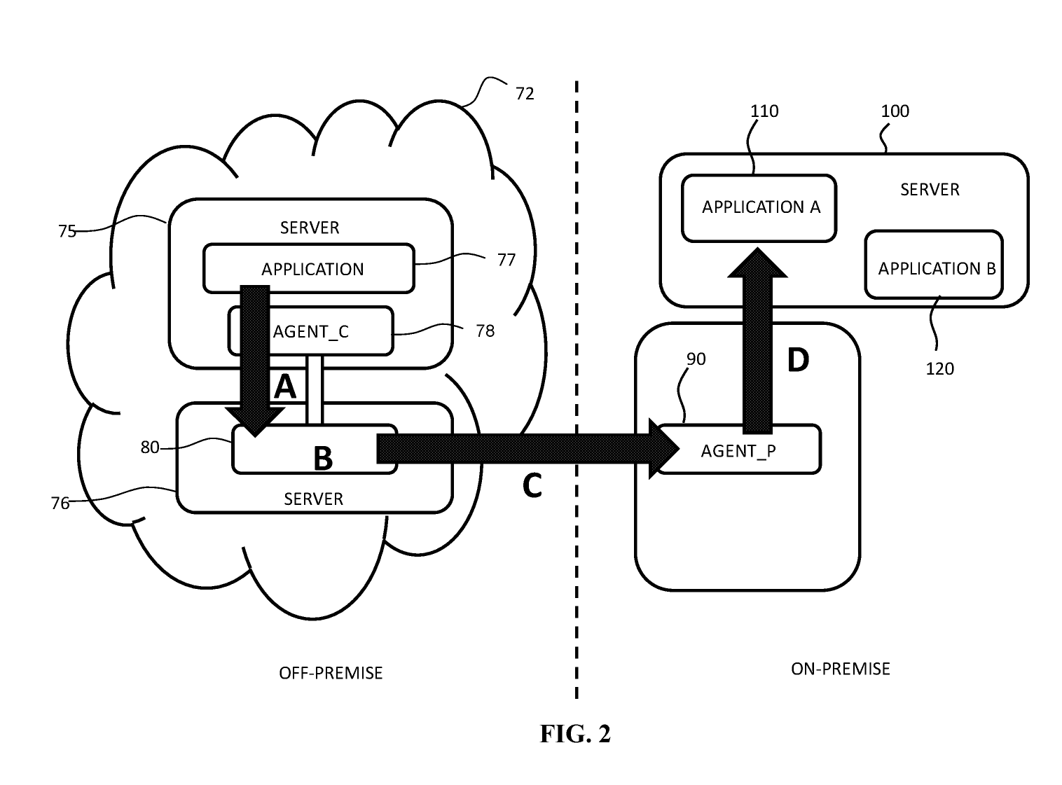

By way of example, and with reference to FIG. 2, an example of a cloud-based application 77 of the first server 75 calling the first application 110 “APPLICATION A” (which resides on an on-premise database server 100) will now be described.

Firstly, as indicated by the arrow labeled “A”, the application 77 of the first server 75 communicates an application request to the switching component 80 via the first server module/agent 78 (labeled “AGENT_C”). This communication is established using a secure tunnel between the first server module/agent 78 (labeled “AGENT_C”) and the first communication component 160 of the switching component 80. The application request in this example comprises: an identification portion including the name of the first application 110, namely SUBAPPLICATION A; an authentication placeholder including incorrect or abstracted authentication information, namely a dummy password of “XXXXXXXXXX”; and payload comprising: event data comprising an application instruction (such as “read” for example); entry point data representing a location a data for the instruction; and payload comprising data representing data to be used by the application 110.

Next, as indicated by the label “B”, the switching component 80 determines the requested application from the identification portion of the application request, and subsequently queries the data store 140 of the switching component 80 to determine application path data associated with the requested application (APPLICATION A).

Based on the determined application path data, the second communication component 170 then communicates the application request to the first application 110 (“APPLICATION A”) of the on-premise resources 73 as indicated by the arrows labeled “C” and “D”. This communication is established using a secure tunnel between the second communication component 170 and the security component 90 (“AGENT_A”). Here, the security component 90 identifies stored authentication data associated with the requested application (e.g. based on the authentication placeholder and the payload of the application request), and modifies the authentication placeholder using the identified authentication data to generate a modified application request comprising authentication information for authorizing the application request. The modified application request is communicated by the second communication component 200 of the security component 90 to the first application 110 (“APPLICATION A”) of the on-premise resources 73 as indicated by the arrow labeled “D”.

Thus, from the above example, it will be seen that the switching component 80, and the security component 90 (“AGENT_A”) manage mutually authenticated TLS connections. In this diagram, the first application 110 is implemented on an on-premise database server 100 and the credentials required to access the database server 100 need only be known to the on-premise resources (and not the off-premise servers).

Further, embodiments may also be adapted to enable the communication of a response from the requested/called application back to the calling application. By way of illustration, in the example depicted in FIG. 2, the second communication component 170 may be adapted to receive a response to the communicated application request. The routing component 150 may then determine intended destination of the response (e.g. based on analysis of the response and/or stored data relating to previously communicated requests) and then pass the response to the first communication component 160 for communication to the application that originated the request (to which the response is responding). In this way, a response to an application request/call may be communicated back to the application (or resource) that originated the request/call. Proposed embodiments may therefore provide for the management and authentication of communication between off-premise and on-premise platforms so that requests and responses are securely delivered whilst avoiding excessive communication traffic.

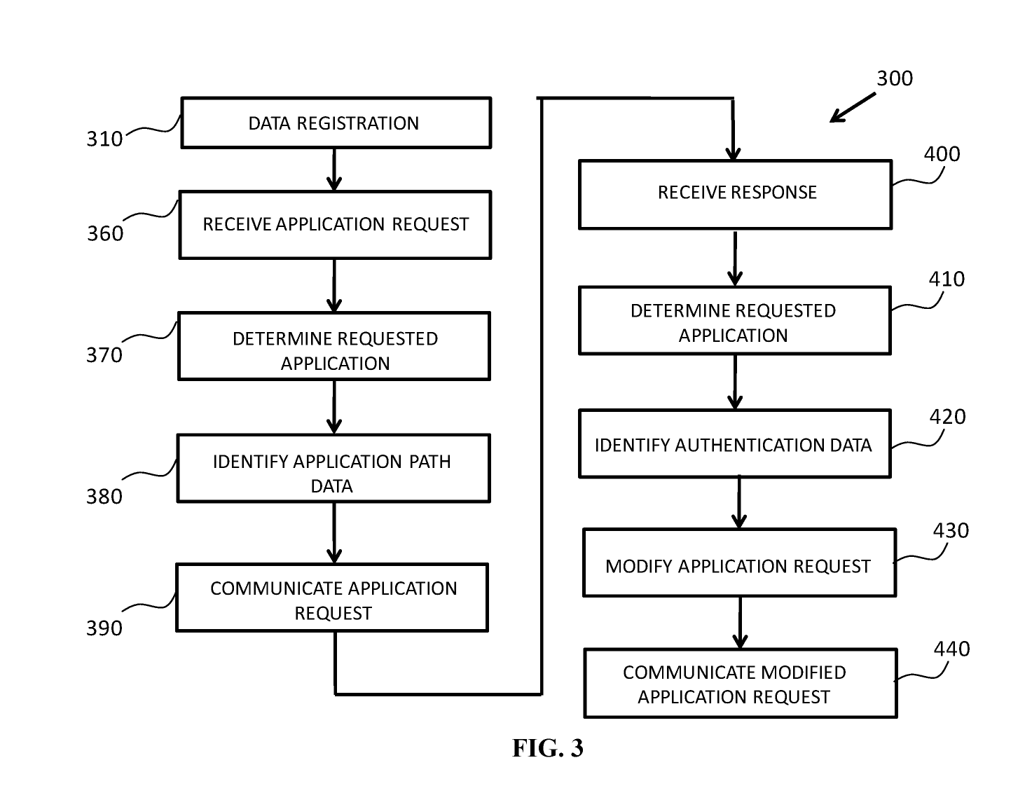

Referring now to FIG. 3, there is depicted a flow diagram of a method 300 for communication between off-premise and on-premise resources according to an embodiment. The method 300 of FIG. 3 is described as being implemented with a connectivity component (e.g. switching module) and a security component according to a proposed embodiment.

The method 300 begins with the step 310 of application path data registration. In other words, the method may initially implement an application path data registration process, so that application path data associated with available applications is stored in a data store of the connectivity component. Once the application path data registration process 310 is completed, and thus the data store is appropriately populated, the method proceeds to step 360.

In step 360, an application request is received by the connectivity component from an application of an off-premise server. Here, the application request is received via a (previously) established secure tunnel. Also, the application request of this example may comprise a request to execute or invoke an application which consists of a header or identification portion, an authentication placeholder portion, and a payload portion. The header/identification portion may include information relating to the identification of the requested application (such as an application name for example), the authentication placeholder may include incorrect, symbolic, figurative, abstract or improper authentication information (such as a false, dummy or empty password field), and the payload portion may comprise a data payload (such as data for use in/by the application for example). The application request may therefore comprise information relating to the application, an event (e.g. read, write, delete, append, purge, edit, etc.) to be completed by the application, an account or user requesting the event, data to be processed by the application, and/or and entry point in the application that the request would be made to. Inclusion of entry point data (such as path identification information, for example) in an application request may enable specification of an entry point in application that the request is made to. For example, an application called “application1” could have two entry points called “entry1” and “entry2”. The application request may then include the application name and the entry point within the application, such as “application1/path1” for example. If no entry point information is employed, a default entry point (e.g. start of application code) may be used. Also, inclusion of the authentication placeholder may enable the request to be in a format or structure that is expected for a security protocol, without actually including private or confidential security information. For example, the authentication placeholder may simply comprise dummy text or characters such as “11111111111” or “*********” in a password field, thus ensuring that the request comprises a password field as required or expected by a security protocol employed by the requested application.

Next, in step 370, the received application request is processed in conjunction with data stored in the data store in order to determine a requested application. For example, the connectivity component analyzes the identification portion of the received application request to identify the requested application (for example, based on an application name included in the identification portion). The method then proceeds to step 380, wherein, based on the identified requested application, the connectivity component queries the data store to identify application path data that is associated with the identified requested application. In other words, based on the identified requested application, the connectivity component searches the data store to find a data entry/record for the requested application and then extracts application path data that is stored in the data entry/record for the requested application.

In step 390, the connectivity component then communicates the application request to an on-premise resource based on the identified application path data. For this purpose, an established secure tunnel is used to communicate the application request to a security component of the on-premise resource.

In step 400, the application request is received by the security component. Next, in step 410, the received application request is processed to identify the requested application. For example, the connectivity component analyzes the identification portion of the received application request to identify the requested application (for example, based on an application name included in the identification portion).

The method then proceeds to step 420, wherein the security component queries stored authentication data to identify authentication data that is associated with the identified requested application. In other words, based on the application request, the security component searches the authentication data store to find authentication data for the request and then extracts authentication data for use in the application request.

In step 430, the security component modifies the authentication placeholder of the application request using the identified/extracted authentication data to generate a modified application request comprising authentication information for authorizing the application request. For example, dummy text or characters such as “11111111111” or “*********” in a password field may be replaced with a correct password extracted from the authentication data store. The modified application request is then communicated by the security component 90 to an on-premise resource based on the identified application path data.

Thus, from the above description of the method of FIG. 3, it will be appreciated that a method of receiving an application request, inserting authentication data at an on-premise resource, and then communicating (e.g. forwarding) the modified request to an appropriate endpoint (e.g. application or server module implementing a requested application) may be provided. It should also be appreciated that the application request, may or may not require a response to be provided (for example, back to the originator of the request).

Purely by way of further example, possible approaches to identifying and/or replacing data of the authentication placeholder may include the following:

(a) If the security protocol is understood for a given transport then the location of the placeholder password could be located and the string replaced safely. For example, MQSeries has fixed size structures with the password at a known offset. With this knowledge, the location of the password may be reliably found. Once the password is replaced, it may not be replaced again for a given connection unless the protocol required it. If the protocol also required a check sum, such as a crc, it could be regenerated to take account of the injected password.

(b) If the security protocol is not understood, instead of putting XXXXXXXX in the password field, a randomly generated string may be created by the on-premises system. The cloud system could be provided with the string and then insert that instead of XXXXXX. This would make it unlikely that the stream would have the password place holder somewhere else in the stream just by chance. To further reduce the chance of collisions, it could only ever replace the first occurrence of the string for any given connection. Another advantage of this approach is that there may be an added level of security because even if the attacker obtained the string the only attack vector would be via the cloud to on-premise connection and not via any other mechanism.

As detailed above, the data store of each of connectivity component and the security component may be dynamically or automatically maintained using a registration/deregistration process. Thus, in addition to implementing a data registration method, a data de-registration method may also be employed. Such processed may be executed in response to changes in connectivity, user(s) or application resources for example.

It will be appreciated that embodiments, such as that presented above with reference to their figures may provide the benefit of reducing the amount of data that passes between data applications in off-premise and on-premise platforms. Further, proposed embodiments may also reduce an amount of private or sensitive information (such a authentication information or security credentials) that passes between application in off-premise and on-premise platforms. It is also noted that embodiments may enable an off-premise application to not need any secure information (e.g. database user credentials, ports, IP addresses, etc.).

As will be apparent from the above description, an off-premise resource may be provided by a cloud-computing system. Also, a connectivity component or method for managing communication between off-premise and on-premise platforms may be provided or implemented by a cloud-computing system. Furthermore, a security component or method for managing authentication between off-premise and on-premise platforms may be provided.

With reference to the following description made with regard to a cloud computing system, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed. The following description of a cloud computing system and environment is made purely for the purposes of explanation and understanding.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This off-premise cloud model may include at least five characteristics, at least three service models, and at least four deployment models.

Characteristics are as follows: On-demand self-service: a cloud consumer can unilaterally provide computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service oriented with a focus on statelessness, low coupling, modularity, and semantic interoperability. At the heart of cloud computing is an infrastructure comprising a network of interconnected nodes.

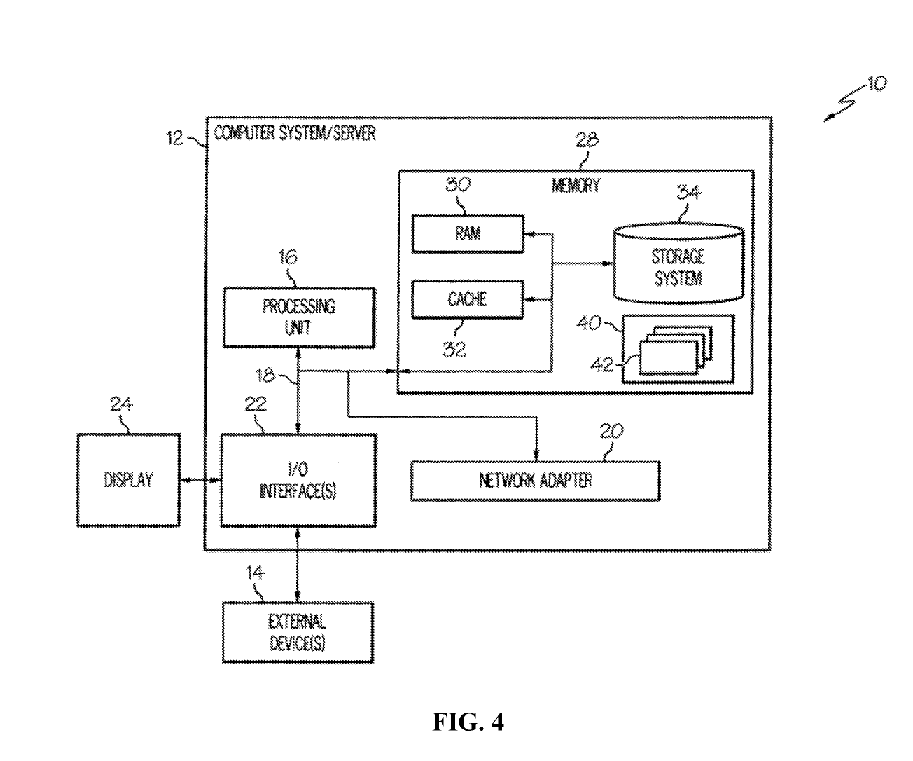

Referring now to FIG. 4, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

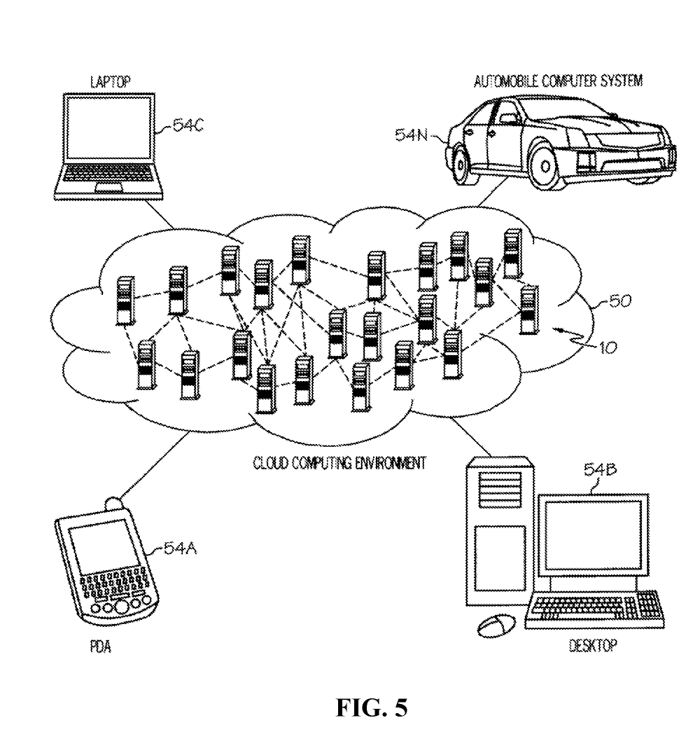

Referring now to FIG. 5, illustrative cloud computing environment or cloud computing system 50 is depicted. This can, in embodiments, be equated to the cloud computing system as depicted in FIG. 1A for example. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

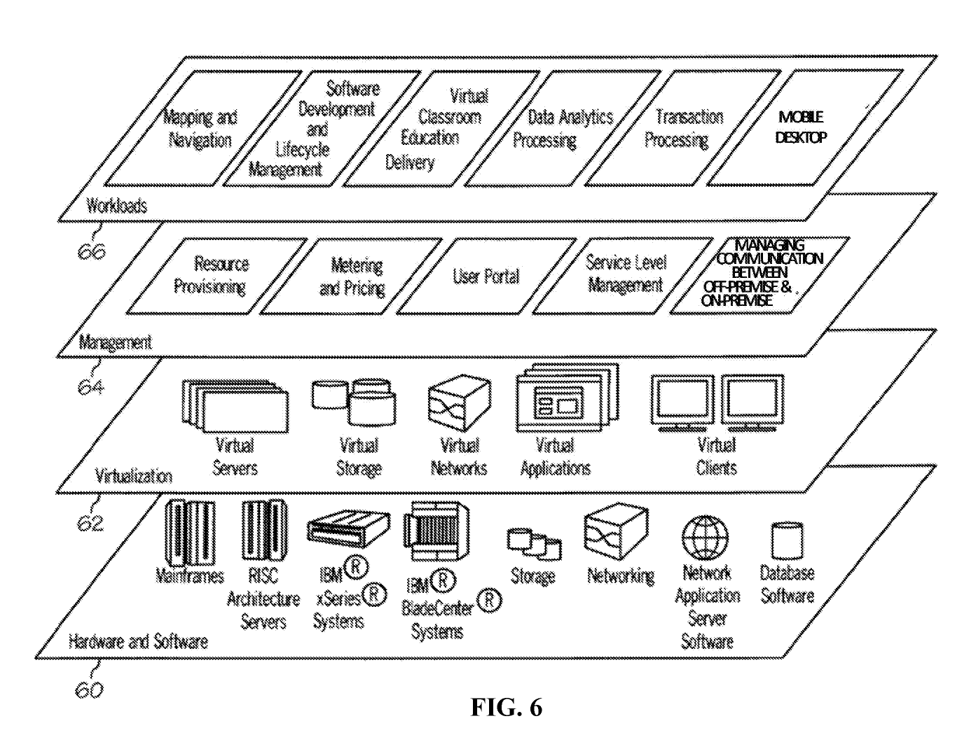

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Managing communication between off-premise and on-premise platforms provides for managing and/or authentication communication according to proposed concepts as detailed above.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A connectivity component for managing communication between off-premise and on-premise servers; the connectivity component comprising:
an application path data store adapted to store application path data associated with one or more applications;
a first communication component adapted to receive an application request from an off-premise server or an on-premise server, the application request comprising an authentication placeholder devoid of correct authentication information for authorizing the application request;
a routing component adapted to determine a requested application based on the received application request and to identify stored application path data associated with the requested application; and
a second communication component adapted to communicate the application event request to an on-premise server or off-premise server based on the identified application path data.

2. The connectivity component of claim 1, wherein the first communication component is adapted to establish a secure tunnel for receiving the application request, and wherein the second communication component is adapted to establish a secure tunnel for communicating the application request.

3. The connectivity component of claim 1, wherein the off-premise server comprises a cloud sever, and wherein application request is provided by a service of the cloud server.

4. The connectivity component of claim 1, wherein the application path data comprises at least one of: an application name; a server identification; a server address; an application version identifier; supported applications; permitted applications; permission information; and checksum information.

5. The connectivity component of claim 1, wherein the application request further comprises at least one of: an application name; a data payload; and entry point data.

6. The connectivity component of claim 1, wherein the first communication component is adapted to receive the application request from an off-premise server, and wherein the second communication component is adapted to communicate the application request to an on-premise server based on the identified application path data.

7. A security component for managing authentication between off-premise and on-premise servers; the authentication component comprising:
an authentication data store adapted to store authentication data associated with one or more applications;
a first communication component adapted to receive an application request from an off-premise server or an on-premise server, the application request being directed to a target on-premise server or off-premise server according to application path data and comprising an authentication placeholder devoid of correct authentication information for authorizing the application request;
an authentication component adapted to determine a requested application based on the received application request, to identify stored authentication data associated with the requested application, and to modify the authentication placeholder using the identified authentication data to generate a modified application request comprising authentication information for authorizing the application request; and
a second communication component adapted to communicate the modified application event request to the target on-premise server or off-premise server.

8. The security component of claim 7, wherein the first communication component is adapted to establish a secure tunnel for receiving the application request, and wherein the second communication component is adapted to establish a secure tunnel for communicating the modified application request.

9. The security component of claim 7, wherein the off-premise server comprises a cloud sever, and wherein application request is provided by a service of the cloud server.

10. The security component of claim 7, further comprising a registration module adapted to receive authentication data from at least one of: an application of an off-premise server; an application of an on-premise server; an off-premise server module; and an on-premise server module, and wherein the registration module is adapted to store received authentication data in the authentication data store, and preferably wherein the registration module is adapted to remove authentication data from the authentication data store in response to at least one of: an application; a server; and a file system becoming inaccessible.

11. The security component of claim 10, wherein the authentication data comprises at least one of: a password; a pin-code; permission information; and checksum information.

12. The security component of claim 7, wherein the first communication component is adapted to receive the application request from an off-premise server, and wherein the second communication component is adapted to communicate the modified application request to a target on-premise server according to application path data associated with the application request.

13. The security component of claim 7, wherein the second communication component is adapted to receive a response to the communicated modified application request, and wherein the first communication component is adapted to communicate the received response to the off-premise server.

14. A computer-implemented method of managing communication between off-premise and on-premise servers, the method comprising:
storing, in an application path data store, application path data associated with one or more applications;
receiving an application request from an off-premise server or an on-premise server, the application request comprising an authentication placeholder devoid of correct authentication information for authorizing the application request;
determining a requested application based on the received application request;
identifying stored application path data associated with the requested application; and
communicating the application request to an on-premise server or off-premise server based on the identified application path data.

15. The method of claim 14, wherein receiving an application request comprises receiving an application request from an off-premise server, and wherein communicating the application request comprises communicating the application request to an on-premise server based on the identified application path data.

16. The method of claim 14, further comprising:
receiving a response to the communicated application request; and
communicating the received response to an originator of the application request.

17. A computer-implemented method of managing authentication between off-premise and on-premise servers; the method comprising:
storing, in an authentication data store, authentication data associated with one or more applications;
receiving an application request from an off-premise server or an on-premise server, the application request being directed to a target on-premise server or off-premise server according to application path data and comprising an authentication placeholder devoid of correct authentication information for authorizing the application request;
determining a requested application based on the received application request;
identifying stored authentication data associated with the requested application;
modifying the authentication placeholder using the identified authentication data to generate a modified application request comprising authentication information for authorizing the application request; and
communicating the modified application request to the target on-premise server or off-premise server.

18. A computer program product for managing authentication between off-premise and on-premise servers, the computer program product comprising a computer readable storage medium having program instructions embodied therewith, the program instructions executable by a processing unit to cause the processing unit to perform a method comprising:
storing, in an authentication data store, authentication data associated with one or more applications;
receiving an application request from an off-premise server or an on-premise server, the application request being directed to a target on-premise server or off-premise server according to application path data and comprising an authentication placeholder devoid of correct authentication information for authorizing the application request;
determining a requested application based on the received application request;
identifying stored authentication data associated with the requested application;
modifying the authentication placeholder using the identified authentication data to generate a modified application request comprising authentication information for authorizing the application request; and
communicating the modified application request to the target on-premise server or off-premise server.
